(19) United States
(12) Patent Application Publication
(10) Pub. No.: US 2025/0058765 A1
(43) Pub. Date: Feb. 20, 2025

(54) METHODS AND SYSTEM FOR STARTING AN ENGINE OF A HYBRID VEHICLE

(71) Applicant: Ford Global Technologies, LLC, Dearborn, MI (US)

(72) Inventors: Justin Badger, Plymouth, MI (US); Wulong Sun, Northville, MI (US); Salvatore Fava, Redford, MI (US)

(21) Appl. No.: 18/449,127

(22) Filed: Aug. 14, 2023

(51) Int. Cl. B60W 20/40; B60W 10/06; B60W 10/08; B60W 10/115

(52) U.S. Cl. CPC B60W 20/40; B60W 10/06; B60W 10/08; B60W 10/115; B60W 2710/0644; B60W 2710/0666; B60W 2710/083

(57) ABSTRACT

Systems and methods for operating an internal combustion engine that is coupled to a power split transmission are described. In one example, the internal combustion engine is cranked via a generator and torque output of the generator is adjusted to reduce noise that may be generated by completing a gear lash crossing.

### FIELD

The present description relates to methods and a system for starting an engine of a hybrid vehicle.

### BACKGROUND AND SUMMARY

A hybrid vehicle may include two or more propulsion sources. The propulsion sources may be comprised of an internal combustion engine, a first electric machine (e.g., a generator), and a second electric machine (e.g., a motor). The motor may serve as a sole propulsion source during low torque demand conditions. Further, the motor may assist the internal combustion engine during high torque demand conditions. During operating conditions when driver demand changes from a lower value to a higher value, the generator may assist starting of the internal combustion engine while the motor propels the vehicle. However, using the generator to start the engine may increase driveline noise. Therefore, it may be desirable to provide a way of starting an internal combustion engine of a hybrid vehicle in a way that reduces a possibility of driveline noise.

The summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of an engine;

FIG. 2 is a schematic diagram of a hybrid vehicle driveline;

FIG. 3 shows a plot of an example engine starting sequence according to the method of FIG. 4;

FIG. 4 shows a flow chart of an example method for starting an engine of a hybrid vehicle;

FIG. 5 shows a block diagram of an example PID controller for a generator;

FIG. 6 illustrates gear lash; and

FIG. 7 illustrates driveline torque transfer versus driveline twist angle with lash crossing.

### DETAILED DESCRIPTION

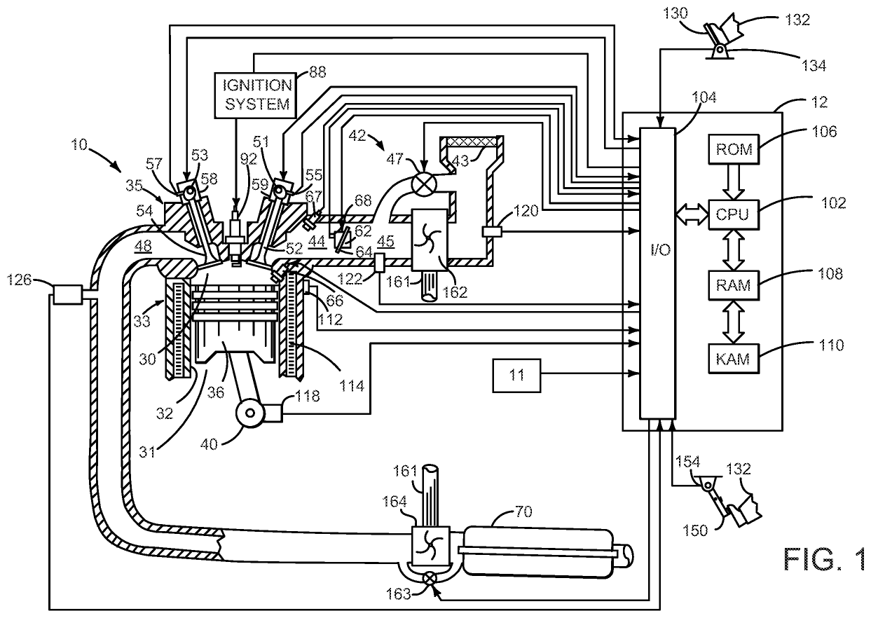

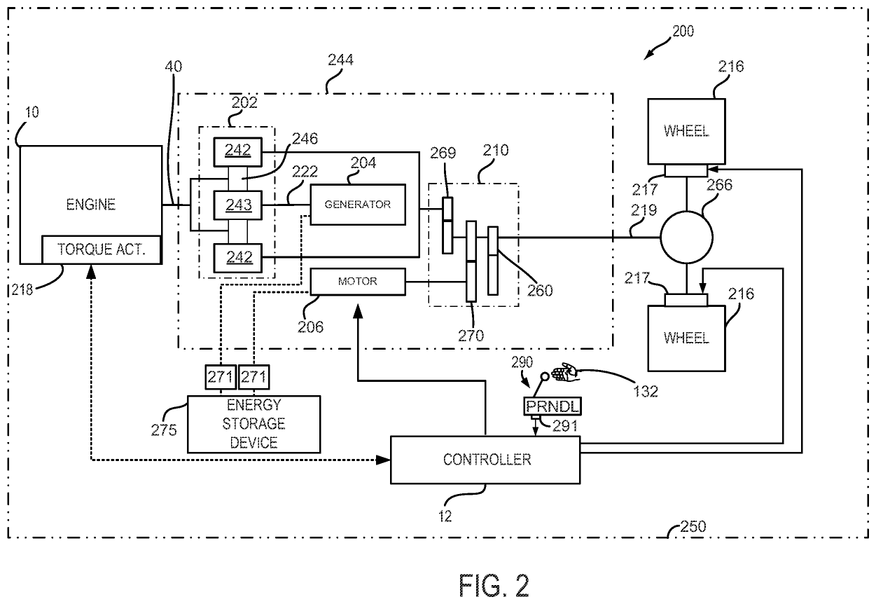

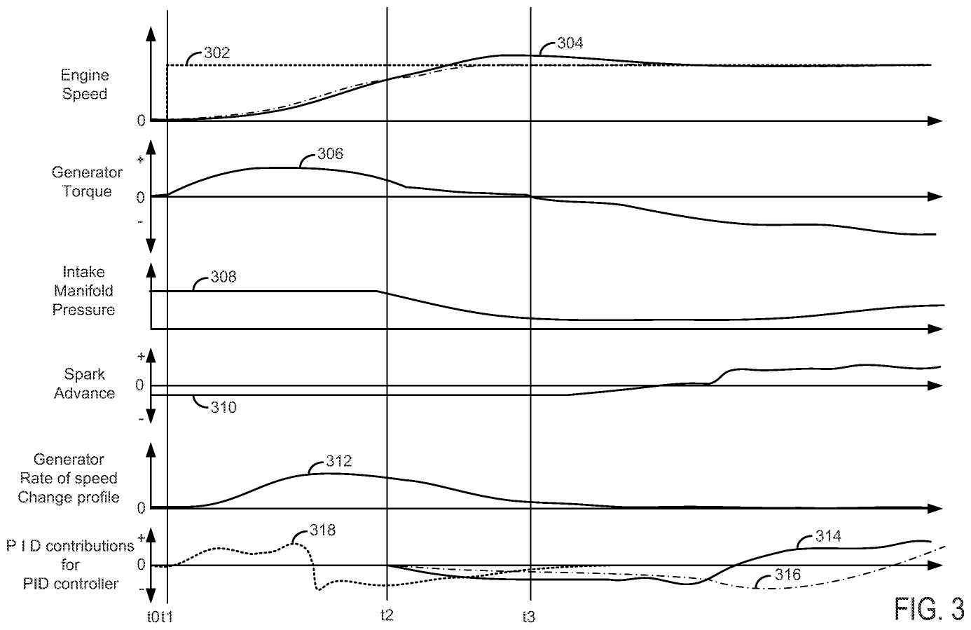

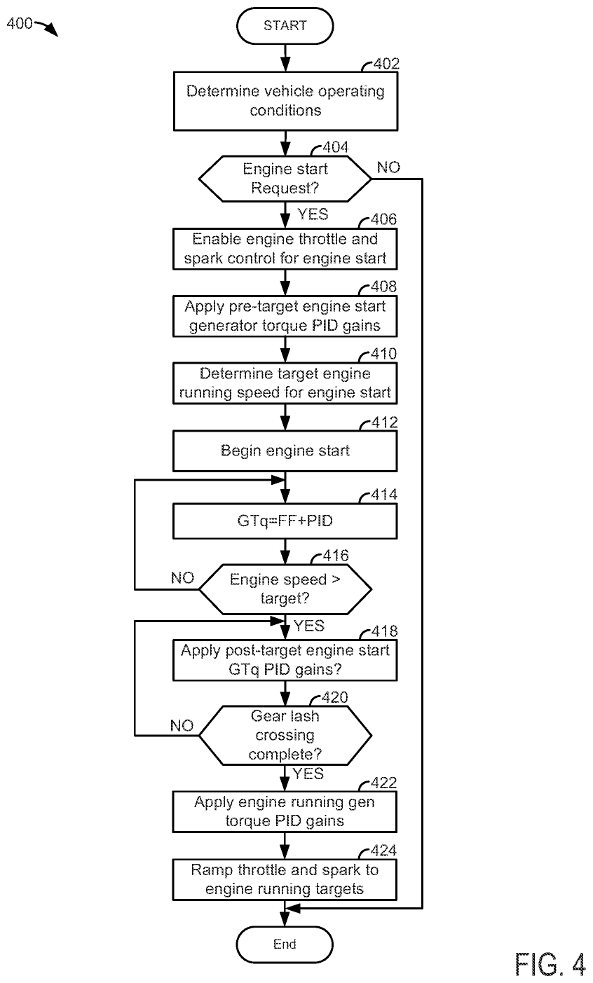

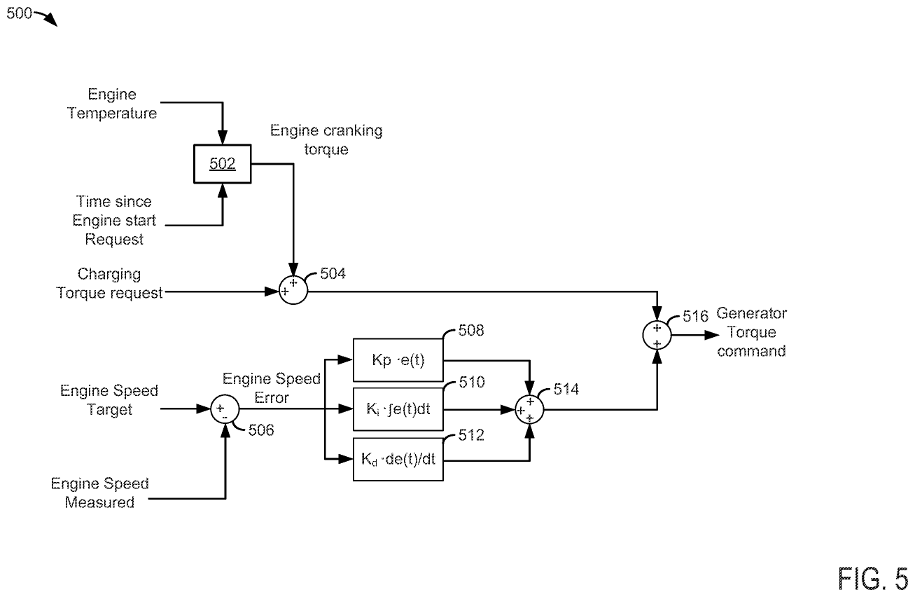

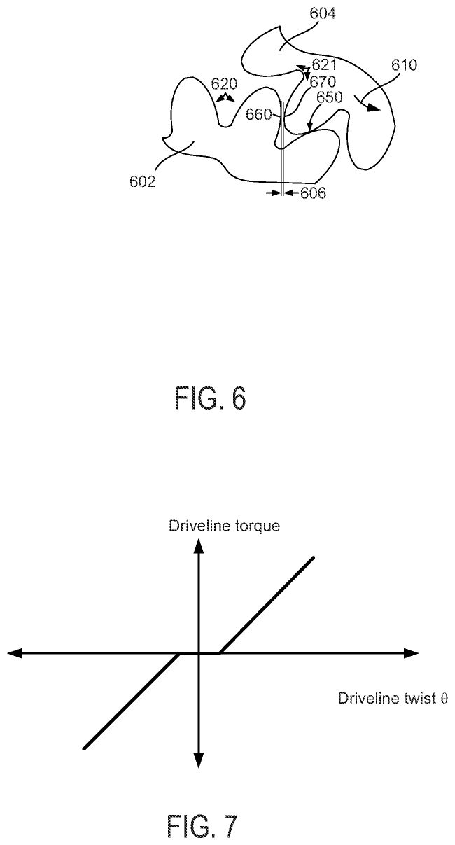

The present description is related to starting a hybrid vehicle. The hybrid vehicle may include an internal combustion engine of the type that is shown in FIG. 1. The internal combustion engine may be included in a driveline that includes a power split transmission as shown in FIG. 2. The power split transmission may include a motor and a generator. The driveline may be operated as shown in FIG. 3 to reduce driveline noise during engine starting. The engine may be started according to the method shown in FIG. 4. Generator torque may be adjusted via a proportional/integral/derivative (PID) controller as shown in FIG. 5. FIGS. 6 and 7 show gear lash for a gear set and its effect on torque transfer through the gear set.

A hybrid vehicle may include a power split transmission. The power split transmission may be comprised of gears including a planetary gear set. The power split transmission may also be configured such that power sources (e.g., internal combustion engines and electric machines) coupled to the power split transmission are continuously coupled to gears within the power split transmission. To reduce a possibility of gears locking, a clearance space may be provided between the gears. However, if torque is delivered to the engine via the gears to begin an engine starting process and the engine subsequently begins delivering torque to the gears, the gear teeth may generate noise as the direction of torque delivery changes. Therefore, it may be desirable to provide a way of starting an engine of a hybrid vehicle that may reduce a possibility of gear noise during engine starting.

The inventors herein have recognized the above-mentioned issues and have developed a method for starting an engine, comprising: via a controller, rotating the engine to a speed greater than a threshold speed via transferring torque from a first electric machine through a planetary carrier gear set and a sun gear to the engine; and reducing torque output of the first electric machine at a rate in response to engine speed being greater than the threshold speed; and ceasing to reduce torque output of the first electric machine at the rate in response to transferring torque from the engine to the first electric machine through the sun gear and to the planetary carrier gear set.

By reducing torque of an electric machine that rotates an engine through a planetary gear set during engine cranking in response to engine speed exceeding a threshold speed, it may be possible to reduce a possibility of generating noise when a gear lash crossing occurs during starting of an engine. In particular, torque generated by an electric machine to crank an engine may allow engine speed to meet a particular speed (e.g., warm or cold engine idle speed) in a short period of time. Once the particular speed is reached, the torque that is output by the electric machine may be reduced at a rate that may slow a relative speed difference between two gear sets during a time period when engine torque output may increase. The lower speed difference between gears may reduce noise that may be generated when speed of a gear that is coupled to the engine increases above a speed of a gear that is mechanically coupled to the electric machine.

The present description may provide several advantages. In particular, the approach may reduce driveline noise during engine starting. Further, the approach may provide greater vehicle starting repeatability. In addition, the approach may reduce driveline wear.

The above advantages and other advantages, and features of the present description will be readily apparent from the following Detailed Description when taken alone or in connection with the accompanying drawings.

Referring to FIG. 1, internal combustion engine 10 (also referred to as “engine”), comprising a plurality of cylinders, one cylinder of which is shown in FIG. 1, is controlled by electronic engine controller 12. The controller 12 receives signals from the various inputs (e.g., sensors) shown in FIGS. 1 and 2. The controller 12 also employs the actuators shown in FIGS. 1 and 2 to adjust engine and driveline operation based on the received signals and instructions stored in memory of controller 12.

Engine 10 is comprised of cylinder head 35 and block 33, which includes combustion chamber 30 and cylinder walls 32 in cylinder 31. Piston 36 is positioned therein and reciprocates via a connection to crankshaft 40. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57. Intake valve 52 may be selectively activated and deactivated by valve activation device 59. Exhaust valve 54 may be selectively activated and deactivated by valve activation device 58. Valve activation devices 58 and 59 may be electro-mechanical devices.

Direct fuel injector 66 is shown positioned to inject fuel directly into combustion chamber 30, which is known to those skilled in the art as direct injection. Port fuel injector 67 is shown positioned to inject fuel into the intake port of combustion chamber 30, which is known to those skilled in the art as port injection. Direct fuel injector 66 and port fuel injector 67 deliver liquid fuel in proportion to pulse widths provided by controller 12. Fuel is delivered to fuel direct fuel injector 66 and port fuel injector 67 by a fuel system (not shown) including a fuel tank, fuel pump, and fuel rail (not shown).

In addition, intake manifold 44 is shown communicating with turbocharger compressor 162 and engine air intake 42. In other examples, turbocharger compressor 162 may be a supercharger compressor. Shaft 161 mechanically couples turbocharger turbine 164 to turbocharger compressor 162. Optional electronic throttle 62 (also referred to as “throttle”) adjusts a position of throttle plate 64 to control air flow from turbocharger compressor 162 to intake manifold 44. Pressure in boost chamber 45 may be referred to a throttle inlet pressure since the inlet of throttle 62 is within boost chamber 45. The throttle outlet is in intake manifold 44. In some examples, throttle 62 and throttle plate 64 may be positioned between intake valve 52 and intake manifold 44 such that throttle 62 is a port throttle. Compressor recirculation valve 47 may be selectively adjusted to a plurality of positions between fully open and fully closed. Waste gate 163 may be adjusted via controller 12 to allow exhaust gases to selectively bypass turbine 164 to control the speed of turbocharger compressor 162. Air filter 43 cleans air entering engine air intake 42.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalyst 70. Alternatively, a two-state exhaust gas oxygen sensor may be substituted for UEGO sensor 126.

Exhaust gases may be processed via catalyst 70. Catalyst 70 can include multiple bricks and a three-way catalyst coating, in one example. In another example, multiple emission control devices, each with multiple bricks, can be used.

Controller 12 is shown in FIG. 1 as a conventional microcomputer including: microprocessor unit 102, input/output ports 104, read-only memory 106 (e.g., non-transitory memory), random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to a driver demand pedal 130 (e.g., a human/machine interface) for sensing force applied by human vehicle driver 132; a position sensor 154 coupled to brake pedal 150 (e.g., a human/machine interface) for sensing force applied by human vehicle driver 132, a measurement of engine manifold pressure (MAP) from pressure sensor 122 coupled to intake manifold 44; an engine position sensor from an engine position sensor 118 sensing crankshaft 40 position; a measurement of air mass entering the engine from sensor 120; and a measurement of throttle position from sensor 68. Barometric pressure may also be sensed (sensor not shown) for processing by controller 12. In a preferred aspect of the present description, engine position sensor 118 produces a predetermined number of equally spaced pulses each revolution of the crankshaft from which engine speed (RPM) can be determined.

Controller 12 may also receive input from human/machine interface 11. A request to start the engine or vehicle may be generated via a human and input to the human/machine interface 11. The human/machine interface 11 may be a touch screen display, pushbutton, key switch or other known device.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC).

During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion.

During the expansion stroke, the expanding gases push piston 36 back to BDC. Crankshaft 40 converts piston movement into a rotational power of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

Referring now to FIG. 2, an example of a driveline 200 is shown. Driveline 200 includes engine 10 and torque actuator 218. Torque actuator 218 may be a throttle, fuel injector, camshaft actuator, ignition system, or other actuator that may adjust engine torque. Engine 10 delivers power to transmission 244 via crankshaft 40. In the depicted example, transmission 244 is a power-split transmission (or transaxle) that includes a planetary gear set 202 that includes one or more rotating gear elements. Transmission 244 further includes an electric generator 204 and an electric motor 206. The electric generator 204 and the electric motor 206 may also be referred to as electric machines as each may operate as either a motor or a generator. Torque may be output from transmission 244 to propel vehicle 250 using traction wheels 216 via a power transfer gearing 210, a torque output shaft 219, and a differential-and-axle assembly 266. A braking torque may be provided via friction or foundation brakes 217.

Electric generator 204 and electric motor 206 are electrically coupled to electric energy storage device 275 such that each of electric generator 204 and electric motor 206 may be operated using electric energy from an electric energy storage device 275 (e.g., a high voltage battery). In some examples, an energy conversion device, such as an inverter 271, may be coupled between the battery and the motor to convert the DC output of the battery into an AC output for use by electric motor 206. Due to the mechanical properties of the planetary gear set 202, electric generator 204 may be driven by a power output element (on an output side) of the planetary gear set 202 via mechanical connection 222.

Electric motor 206 may be operated in a regenerative mode, that is, as a generator, to absorb kinetic energy from the vehicle and/or the engine and convert the absorbed kinetic energy to an energy form suitable for storage in electric energy storage device 275. In addition, electric motor 206 may be operated as a motor or generator, as required, to augment or absorb torque provided by the engine, such as during a transition of engine 10 between different operating modes.

Planetary gear set 202 comprises a ring gear 242, a sun gear 243, and planetary carrier gear set 246. Planetary gears included in the planetary carrier gear set 246 may interface directly with the sun gear 243 and the ring gear 242. The ring gear and sun gear may be coupled to each other via the planetary carrier gear set 246. Crankshaft 40 of engine 10 is mechanically coupled to planetary carrier gear set 246 and sun gear 243 is mechanically coupled to generator 204. Ring gear 242 is mechanically coupled to power transfer gearing 210 including one or more meshing gear elements 260. Electric motor 206 drives gear element 270 and electric generator 204 is coupled to sun gear 243. In this way, the planetary carrier gear set 246 (and consequently the engine and generator) may be coupled to the vehicle's wheels and the electric motor 206 via one or more gear elements.

Hybrid propulsion system or driveline 200 may be operated in various modes including a full hybrid mode, wherein the vehicle is driven solely by engine 10 and electric generator 204 cooperatively, or solely the electric motor 206, or a combination of the same. Alternatively, assist or mild hybrid examples may also be employed, wherein the engine 10 is the dominant source of power and the electric motor 206 selectively adds torque during specific conditions, such as during a driver demand tip-in event (e.g., application of the driver demand pedal).

The vehicle may be driven in a first engine-on mode, which may be referred to as an “engine” mode, wherein engine 10 is operated in conjunction with the electric generator 204 (which provides reaction torque to the planetary gear-set and allows a net planetary output torque for propulsion of the vehicle) and used as the dominant source of power and torque for powering traction wheels 216. In this mode, electric generator 204 may generate electric power, and the electric power generated may be applied by the drive motor 206 to propel the vehicle as well. This may result in no net power being delivered to the electric energy storage device 275 or the high voltage accessories from the engine power. If the drive motor 206 did not use the generator power, that generator power would have to be used by the high voltage accessories or to charge the high voltage battery. All power generated by the engine is consumed in a power split system. During the “engine” mode, fuel may be supplied to engine 10 from a fuel tank via direct fuel injector 66 so that the engine can spin fueled to provide the torque for propelling the vehicle. Specifically, engine power is delivered to the ring gear 242 of the planetary gear set 202, thereby delivering power to traction wheels 216. Optionally, the engine may be operated to output more torque than is needed for propulsion, in which case the additional power may be absorbed by electric generator 204 (in a generating mode) to charge electric energy storage device 275 or supply electrical power for other vehicle electrical loads.

In another example, the hybrid propulsion system may be driven in a second engine-on mode, which may be referred to as an “assist” mode. During assist mode, engine 10 is operated and used as the dominant source of torque for powering traction wheels 216 and electric motor 206 is used as an additional torque source to act in cooperation with, and supplement the torque provided by engine 10. During the “assist” mode, as in the sole engine mode, fuel is supplied to engine 10 so as to spin the engine fueled and provide torque to the vehicle wheels.

In still another example, the hybrid propulsion system or driveline 200 may be driven in an engine-off mode, which may be referred to as a sole electric mode, wherein battery powered electric motor 206 is operated and used as the sole source of power for driving traction wheels 216. As such, during the engine-off mode, no fuel may be injected to engine 10 irrespective of whether the engine is spinning or not. The “engine-off” mode may be employed, for example, during braking, while no loads request engine power, or when propulsion is not needed, such as while the vehicle is stopped at traffic signals, etc. Specifically, motor power is delivered to gear element 270, which in turn drives the meshing gear elements 260, thereby driving traction wheels 216. The generator 204 spins so that all of the rotation of gear 242 is balanced and ring gear 242 has a net zero speed, thereby allowing the engine to not spin.

During the engine-off mode, based on vehicle speed and driver demand torque, the vehicle may be operated in a first sole electric mode, wherein the vehicle is propelled by the electric energy storage device 275 via the electric motor 206 with the engine not spinning and not fueled, or in a second sole electric mode wherein the vehicle is propelled by the electric energy storage device 275 via electric motor 206 with the engine spinning unfueled. During the second sole electric mode, the electric generator 204 applies torque to planetary gear set 202 through sun gear 243. The planetary carrier gear set 246 provides reaction torque to this generator torque, and consequently directs torque to the engine 10 to spin the engine 10. In this example, the reaction torque provided by planetary carrier gear set 246 is supplied to motor 206 (or alternatively vehicle momentum when vehicle speed is decreasing), and consequently reduces torque from the motor to the wheels.

Shifter 290 may receive input from human vehicle driver 132 to select an operating mode for transmission 244. Shifter 290 may be placed into one of a plurality of positions or states as indicated by PRNDL. A driver may request that transmission 244 be in park when shifter 290 is moved to the “P” position. The driver may request that the transmission 244 be in reverse when shifter 290 is in the “R” position. The driver may request that the transmission 244 be in neutral when shifter 290 is in the “N” position. The driver may request that the transmission 244 be in drive when shifter 290 is in the “D” position. The driver may request that the transmission 244 be in low when shifter 290 is in the “L” position. Note that a low selection in the power split system is not a gear selection. Rather, it simulates engine braking when the drive demand pedal is fully released by generating more regenerative braking torque and/or spinning the engine unfueled to generate a torque on the wheels to reduce vehicle speed. The position of shifter 290 may be determined via shifter position sensor 291.

Thus, the system of FIGS. 1 and 2 provides for a system, comprising: an internal combustion engine; a power split transmission coupled to the internal combustion engine, the power split transmission including two electric machines, a sun gear, a planetary carrier gear set, and a ring gear; and a controller including executable instructions stored in non-transitory memory that cause the controller to rotate the internal combustion engine via a first electric machine of the two electric machines to start the internal combustion engine, and additional executable instructions reduce torque output of the first electric machine at a rate in response to a speed of the internal combustion engine exceeding a threshold speed, and additional instructions to further adjust torque output of the first electric machine in response to lash crossing between the sun gear and the planetary carrier gear set during engine starting. In a first example, the system further comprises additional instructions that cause the controller to initiate combustion in the internal combustion engine. In a second example that may include the first example, the system further comprises additional instructions that cause the controller to retard spark timing of the internal combustion engine and operate the internal combustion engine with a throttle of the internal combustion engine fully closed during starting of the internal combustion engine. In a third example that may include one or both of the first and second examples, the system further comprises additional instructions to adjust control parameters of a proportional integral derivative controller to a first set of values during engine starting. In a fourth example that may include one or more of the first through third examples, the system further comprises additional instructions adjust control parameters of the proportional integral derivative controller to a second set of values in response the speed of the internal combustion engine exceeding the threshold speed. In a fifth example that may include one or more of the first through fourth examples, the system further comprises additional instructions to adjust control parameters of the proportional integral derivative controller to a third set of values in response the lash crossing between the sun gear and the planetary gear set. In a sixth example that may include one or more of the first through fourth examples, the system includes where the proportional integral derivative controller adjusts torque output of the first electric machine. In a seventh example that may include one or more of the first through sixth examples, the system further comprises additional instructions to propel a vehicle via a second electric machine of the two electric machines.

Referring now to FIG. 3, example plots of a prophetic engine starting sequence are shown. The engine starting sequence may be performed via the system of FIGS. 1 and 2 in cooperation with the method of FIG. 4. Vertical lines at times t0-t3 represent times of interest during the sequence. The plots in FIG. 3 are time aligned and occur at the same time.

The first plot from the top of FIG. 3 is a plot of engine speed versus time. The vertical axis represents engine speed and engine speed increases in the direction of the vertical axis arrow. Dashed line trace 302 represents a target or requested engine speed. Dash dot line trace 303 represents a filtered target or requested engine speed. The filtered target engine speed is the target engine speed value that has passed through a low pass filter. Solid line trace 304 represents measured or actual engine speed. The horizontal axis represents time and time increases from the left side of the plot to the right side of the plot.

The second plot from the top of FIG. 3 is a plot of generator torque versus time. The vertical axis represents generator torque and generator torque is positive (e.g., delivering torque to rotate gears in the planetary carrier gear set) when trace 306 is above the horizontal axis. Generator torque is negative (e.g., absorbing torque from the planetary carrier gear set to charge the traction battery) when trace 306 is below the horizontal axis. The horizontal axis represents time and time increases from the left side of the figure to the right side of the figure. Trace 306 represents generator torque.

The third plot from the top of FIG. 3 is a plot of engine intake manifold pressure versus time. The vertical axis represents engine intake manifold pressure and engine intake manifold pressure increases in the direction of the vertical axis arrow. Trace 308 represents the engine intake manifold pressure. The horizontal axis represents time and time increases from the left side of the figure to the right side of the figure.

The fourth plot from the top of FIG. 3 is a plot of engine spark timing versus time. The vertical axis represents engine spark timing and engine spark timing is advanced from a minimum spark advance for a maximum torque generated at a particular engine speed and load (e.g., MBT spark timing) when trace 310 is above the horizontal axis. Engine spark timing is retarded from MBT spark timing when trace 310 is below the horizontal axis. Trace 310 represents the engine spark timing. The horizontal axis represents time and time increases from the left side of the figure to the right side of the figure.

The fifth plot from the top of FIG. 3 is a plot of generator rate of speed change versus time. The vertical axis represents generator rate of speed change and the rate of generator speed change increase in the direction of the vertical axis arrow. Trace 312 represents the generator rate of speed change. The horizontal axis represents time and time increases from the left side of the figure to the right side of the figure.

The sixth plot from the top of FIG. 3 is a plot of PID contributions for the PID controller versus time. The vertical axis represents PID contribution values. Trace 314 represents the proportional contribution (e.g., Kₚ·e(t)) to the PID controller output. Trace 316 represents the integral contribution (e.g., Kᵢ·∫e(t)dt) to the PID controller output. Trace 318 represents the derivative contribution (e.g., K_{d}·de(t)/dt) to the PID controller output. The horizontal axis represents time and time increases from the left side of the figure to the right side of the figure.

At time t0, the engine is off (e.g., not rotating and not combusting fuel) and generator torque is zero. The intake manifold pressure is elevated and spark timing is set to a retarded value. The generator rate of speed change is zero and PID contributions to the PID controller output are zero.

At time t1, an engine start is requested (not shown) so the target engine speed is increased. The filtered target engine speed begins to increase and the actual or measured engine speed begins to increase as torque of the generator is increased. The generator begins to rotate the engine shortly after time t1. The PID controller is loaded with a first group of PID control parameters (e.g., Kₚ₁, Kᵢ₁, and K_{d1}) (not shown) to control generator torque during engine run-up. The derivative contribution to the PID controller output moves off a zero value to a positive value.

Between time t1 and time t2, the engine speed increases and generator torque increase and then begins to decrease. The intake manifold pressure remains high and spark timing is unchanged. The rate of generator speed change increases and then it decreases.

At time t2, the actual engine speed or measured engine speed exceeds the filtered target engine speed so the PID control parameters are switched to different values (e.g., Kₚ₂, Kᵢ₂, and K_{d2}) (not shown). This causes the P, I, and D contributions to the PID controller output to move off of zero and move in a negative direction in this example. Output of the PID controller reduces the generator output torque. In addition, the generator rate of speed change is reduced as the generator output torque is reduced toward zero in response to the PID control parameter change. Reducing the generator output torque may reduce a possibility of a torque disturbance during gear lash crossover, which may occur when a gear that was driven by a gear that is coupled to the generator begins to drive the gear that is coupled to the generator. The engine intake manifold pressure begins to be pumped down and engine spark timing remains retarded.

Between time t2 and time t3, the engine speed continues to increase and then it levels off. The generator torque is adjusted to be reduced at a lower rate as the gear lash crossover begins to approach. The intake manifold pressure continues to be reduced and the spark timing remains retarded. The low intake manifold pressure and retarded spark timing may permit the engine to generate very little torque to rotate the engine so that the engine starting may not cause the planetary carrier gear set to overdrive the sun gear. The P, I, and D contributions continue to be adjusted.

At time t3, the transmission gear lash crossover occurs. The P, I, and D control parameters are changed again so that the generator may respond as desired during engine running conditions. The engine throttle may be opened and spark timing may be advance to increase engine torque output once the gear lash crossover has occurred. However, since the engine was generating little torque during the transmission gear lash crossover and since generator torque output was low, noise that may be caused by gear meshing during the gear lash crossover may have been reduced. The generator begins to apply a load to the engine and generate electric charge shortly after time t3.

In this way, noise caused by gear meshing following gear lash crossover may be reduced. In some examples, engine intake manifold pressure, spark timing, and generator torque may be open loop adjusted as shown based on time or an actual number of cylinder cycles since a most recent engine start request. However, adjusting these vehicle operating states via a PID controller as described herein may provide more repeatable and robust engine starting.

Referring now to FIG. 4, a flow chart of a method for staring an engine of a hybrid vehicle with a power split transmission is shown. The method of FIG. 4 may be incorporated into and may cooperate with the system of FIGS. 1 and 2. Further, at least portions of the method of FIG. 4 may be incorporated as executable instructions stored in non-transitory memory while other portions of the method may be performed via a controller transforming operating states of devices and actuators in the physical world.

At 402, method 400 determines vehicle operating conditions. Vehicle operating conditions may include but are not limited to vehicle status (e.g., activated/deactivated), engine operating state, battery system operating state, electric machine operating state, brake system operating state, transmission gear shifter position, driver demand torque, braking torque, and vehicle operating mode. Method 400 may determine the vehicle operating conditions via the sensors described herein. Method 400 proceeds to 404.

At 404, method 400 judges whether or not an engine start is requested. An engine start may be requested via operator input or based on vehicle operating conditions. For example, an engine start may be requested when battery state of charge is low and when a vehicle operator activates the vehicle. Further, an automatic engine start may be requested in response to increasing driver demand torque, low state of battery charge, an amount of time since a last engine start, etc. If method 400 judges that an engine start is requested, the answer is yes and method 400 proceeds to 406. Otherwise, the answer is no and method 400 proceeds to exit.

At 406, method 400 enables engine throttle and spark control. The controller may look up requested throttle opening amount and spark timings from tables or functions stored in controller memory. The tables or functions may be indexed or referenced by vehicle operating conditions. Values in the tables or functions may be empirically determined during engine starting procedures where engine emissions and combustion stability are monitored.

It may be desirable to start the engine with a low intake manifold pressure and spark that is retarded from MBT spark timing so that the engine may not increase a speed differential between gears of the power split transmission during engine starting. If the engine generates a large amount of torque, the engine may cause one gear from being a driven gear to being a driving gear, thereby transitioning a gear lash crossing as discussed with regard to FIG. 6. Therefore, method 400 may minimize engine torque output during engine start and run-up prior to a first gear lash crossing since a most recent engine stop.

For example, during a warm engine start, the engine throttle may be fully closed and spark timing retarded from MBT spark timing to reduce engine torque. The engine spark timing retard and throttle opening minimization may be limited to provide a desired level of combustion stability so that engine emissions and noise may meet metrics. On the other hand, during cold engine starts, the throttle may be opened a small amount and spark may be less retarded from MBT spark timing as compared to when the engine is started warm. Method 400 adjusts the throttle opening amount and spark timing in response to engine temperature and ambient air temperature. Method 400 proceeds to 408.

At 408, method 400 installs a first group of PID controller control parameters into a PID controller. The first group of PID control parameters may ensure that actual engine speed closely follows desired engine speed during engine run-up. The first group of control parameters may include a first proportionate scaling factor or gain (e.g., a scalar real number) that is represented by the variable Kₚ₁. The numeric value for Kₚ₁ may depend on the vehicle components and vehicle performance criteria. The first group of control parameters may also include a first integral scaling factor or gain (e.g., a scaler real number) that is represented by the variable Kᵢ₁. The numeric value for Kᵢ₁ may depend on the vehicle components and vehicle performance criteria. The first group of control parameters may also include a first derivative scaling factor or gain (e.g., a scaler real number) that is represented by the variable K_{d1}. The numeric value for K_{d1} may depend on the vehicle components and vehicle performance criteria. The PID controller is populated with these values and the PID controller adjusts generator torque. Method 400 proceeds to 410.

At 410, method 400 determines a target engine running speed or a target speed. In one example, the target speed may be empirically determined based on engine emissions, ambient temperature, engine temperature, vehicle operating mode, and time since engine start. In particular, the engine may be started while engine emissions and combustion stability are monitored. A table or function may include empirically determined target engine speed values for engine starting. Method 400 may index or reference the table or function according to vehicle operating conditions and the table or function outputs a target engine speed. In some examples, method 400 may pass the target engine speed through a first order low pass filter to generate a filtered target engine speed. The filtered target engine speed may provide smooth engine speed transitions, which may be desirable from a user perspective. Method 400 proceeds to 412.

At 412, method 400 begins the engine start. The engine start may begin the engine start by positioning the throttle to the requested throttle position, activating engine spark timing, activating the engine fuel pump, etc. Method 400 proceeds to 414.

At 414, method 400 adjusts the generator torque. The engine start may include adjusting generator torque in response to the target engine speed, or alternatively, the filtered target engine speed. An open loop feed forward torque value and a feedback torque value generated via a PID controller may be combined to generate a generator torque demand. In one example, the generator torque demand may be generated via a controller as shown in FIG. 5. Thus, the commanded generator torque may be expressed by the following equation:

$$GTq = FF + PID$$

where GTq is the requested or commanded generator torque, FF is the requested feed forward torque and PID is a generator torque adjustment determined via a PID controller that is applying the first group of PID control parameters. The generator is commanded to the requested generator torque. The generator may be commanded via commanding an inverter. Method 400 proceeds to 416.

At 416, method 400 judges whether or not engine speed is greater that the target engine speed, or alternatively, if engine speed is greater than filtered target engine speed. If so, the answer is yes and method 400 proceeds to 418. If not, method 400 returns to 414.

At 418, method 400 method 400 installs a second group of PID controller control parameters into a PID controller, the second group different than the first group of PID control parameters. The second group of PID control parameters may ensure that the rate of actual engine speed changes at less than a threshold rate. This may allow the driveline to approach gear lash crossover at a lower rate, thereby reducing a possibility of generating objectionable driveline noise. The second group of control parameters may include a proportionate scaling factor or gain (e.g., a scalar real number) that is represented by the variable Kₚ₂. The numeric value for Kₚ₂ may depend on the vehicle components and vehicle performance criteria. The second group of control parameters may also include an integral scaling factor or gain (e.g., a scaler real number) that is represented by the variable Kᵢ₂. The numeric value for Kᵢ₂ may depend on the vehicle components and vehicle performance criteria. The second group of control parameters may also include a derivative scaling factor or gain (e.g., a scaler real number) that is represented by the variable K_{d2}. The numeric value for K_{d2} may depend on the vehicle components and vehicle performance criteria. The PID controller is populated with these values and the PID controller adjusts generator torque. Method 400 proceeds to 420.

At 420, method 400 judges whether or not a first gear lash crossing since engine speed was most recently less than a threshold speed has occurred. In one example, method 400 determines the presence or absence of a first gear lash crossing according to the method described in U.S. Pat. No. 8,733,183, which is hereby fully incorporated by reference for all intents and purposes. In other examples, gear lash crossing may be estimated according to a difference in rotational speeds of transmission gears. If method 400 judges that a first gear lash crossing since engine speed was most recently less than a threshold speed has occurred, the answer is yes and method 400 proceeds to 422. Otherwise, the answer is no and method 400 returns to 418.

At 422, method 400 method 400 installs a third group of PID controller control parameters into a PID controller, the third group different than the first and second groups of PID control parameters. The third group of PID control parameters may ensure that the generator responds as desired when the engine is running. The third group of control parameters may include a proportionate scaling factor or gain (e.g., a scalar real number) that is represented by the variable Kₚ₃. The numeric value for Kₚ₃ may depend on the vehicle components and vehicle performance criteria. The third group of control parameters may also include an integral scaling factor or gain (e.g., a scaler real number) that is represented by the variable Kᵢ₃. The numeric value for Kᵢ₃ may depend on the vehicle components and vehicle performance criteria. The third group of control parameters may also include a derivative scaling factor or gain (e.g., a scaler real number) that is represented by the variable K_{d3}. The numeric value for K_{d3} may depend on the vehicle components and vehicle performance criteria. The PID controller is populated with these values and the PID controller adjusts generator torque. Method 400 proceeds to 424.

At 424, method 400 adjusts the engine throttle position and spark timing to base nominal values that are based on engine operating conditions. The engine may operate at or near MBT spark timing and a throttle position that varies in response to driver demand torque. Method 400 proceeds to exit.

In this way, torque of a generator may be adjusted during engine starting and shortly thereafter to reduce a possibility of noise being generated by a change in torque transfer through a set of gears. The approach may adjust the generator torque and/or engine torque via adjusting PID control parameters, or alternatively, as a function of time. However, adjusting the torque via the PID control parameters may be a more robust solution.

Thus, the method of FIG. 4 provides for a method for starting an engine, comprising: via a controller, rotating the engine to a speed greater than a threshold speed via transferring torque from a first electric machine through a planetary carrier gear set and a sun gear to the engine; and reducing torque output of the first electric machine at a rate in response to engine speed being greater than the threshold speed; and ceasing to reduce torque output of the first electric machine at the rate in response to transferring torque from the engine to the first electric machine through the sun gear and to the planetary carrier gear set. In a first example, the method further comprises combusting fuel in the engine while the engine is being rotated via the first electric machine. In a second example that may include the first example, the method includes where combusting fuel in the engine includes operating the engine with spark timing retarded from MBT spark timing. In a third example that may include one or both of the first and second examples, the method includes where combusting fuel in the engine includes fully closing a throttle of the engine. In a fourth example that may include one or more of the first through third examples, the method includes where reducing torque output of the first electric machine includes adjusting torque output of the first electric machine from a positive torque to a negative torque. In a fifth example that may include one or more of the first through fourth examples, the method further comprises charging a battery via the first electric machine in response to transferring torque from the engine to the first electric machine. In a sixth example that may include one or more of the first through fifth examples, the method further comprises advancing spark timing in response to transferring torque from the engine to the first electric machine.

The method of FIG. 4 also provides for a method for operating an engine, comprising: via a controller, rotating the engine via adjusting torque of an electric machine based on output of a proportionate integral derivative (PID) controller operating with a first group of control parameters in response to an engine start request; adjusting torque of the electric machine based on output of the PID controller operating with a second group of control parameters in response to engine speed exceeding a threshold speed; and adjusting torque of the electric machine based on output of the PID controller operating with a third group of control parameters in response to a gear lash crossing having occurred. In a first example, the method includes where the second group of control parameters operate to reduce a rate of torque change of the electric machine. In a second example that may include the first example, the method further comprises combusting fuel in the engine and operating the engine with spark timing retarded from MBT spark timing. In a third example that may include one or both of the first and second examples, the method includes where the gear lash crossing is a first gear lash crossing since a most recent engine stop. The method of claim 19, further comprising operating the engine with a fully closed throttle prior to the gear lash crossing having occurred.

Referring now to FIG. 5, a block diagram of an example PID controller for adjusting generator torque is shown. The PID controller shown in FIG. 5 may be applied in the method of FIG. 4 to control gear lash crossing following a most recent engine start.

Block diagram 500 includes a PID controller with a feed forward term. The feed forward term in this example includes torque for battery charging and engine cranking torque. Engine cranking torque may be determined via referencing a table or function in block 502. The table or function may be referenced via time since the most recent engine start request and engine temperature. The table or function in block 502 outputs a requested engine cranking torque. The requested engine cranking torque is summed with a battery charging torque at summing junction 504. The battery charging torque may be a value of zero until the engine is running and the gear lash crossing has occurred. The output of summing junction 504 is delivered to summing junction 516.

At summing junction 506, actual or measured engine speed is subtracted from a target engine speed, or alternatively, a low pass filtered target engine speed to generate an engine speed error. The engine speed error is delivered to blocks 508-512. At block 508, a proportional scalar or gain (e.g., a real number) variable Kₚ is multiplied by the engine speed error (e) that is a function of time to generate a proportional component of the PID controller output. Block 508 outputs the proportional component of the PID controller to summing junction 514. At block 510, an integral scalar or gain (e.g., a real number) variable Kᵢ is multiplied by the integral of the engine speed error (e) to generate an integral component of the PID controller output. Block 510 outputs the integral component of the PID controller to summing junction 514. At block 512, a derivative scalar or gain (e.g., a real number) variable K_{d} is multiplied by the derivative of engine speed error (e) to generate a derivative component of the PID controller output. Block 512 outputs the proportional component of the PID controller to summing junction 514. The PID control adjustment to generator torque is output from summing junction 514 to summing junction 516 where it is added with the output of summing junction 504 to generate a generator torque demand. The generator torque demand may be sent to the generator or an inverter that controls the generator.

Turning now to FIG. 6, portions of gears are shown to illustrate gear backlash and gear lash crossing. A first gear 602 includes teeth 620. Similarly, a second gear 604 includes teeth 621. The teeth 620 of first gear 602 mesh with teeth 621 of second gear 604. In this example, second gear 604 is the driven gear that is driving first gear 602 such that teeth 621 contact teeth 620 at contact zone 650. To allow the gear teeth to freely mesh without locking, a small space or gap 606 between teeth that are meshing may be provided as shown. This gap 606 may result in a “dead band” of torque transfer when a direction of torque applied to the gears changes. The gap 606 may be referred to as “backlash.” Gear lash crossing may refer to the situation when movement between the teeth occurs to remove the back lash when a direction of torque transfer through the gear set changes. For example, in FIG. 6 the gap 606 is at its greatest extent as shown. However, if torque is applied to first gear 602 such that tooth face 660 moves relative to tooth face 670 and comes in contact with tooth face 670, a gear lash crossing event has occurred since the gap is now reduced to zero.

Turning now to FIG. 7, a plot of driveline torque as a function of driveline twist angle θ is shown. The vertical axis represents driveline torque and driveline torque above the horizontal axis is positive (e.g., torque is added to the driveline) and driveline torque below the horizontal axis is negative (e.g. torque is removed from the driveline). The horizontal axis represents a twist angle of the driveline. Twist angles to the left of the vertical axis are negative angles and twist angles that are to the right of the vertical axis are positive angles. It may be observed that for small positive and negative twist angles, no torque is transferred via the gear set. This condition is present during a lash crossing event and it may be noticeable to vehicle occupants as a change in driveline torque and/or an audible noise that is generated when torque transfer begins and the teeth positively mesh.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, single cylinder, I3, I4, I5, V6, V8, V10, and V12 engines operating in natural gas, gasoline, diesel, or alternative fuel configurations could use the present description to advantage.

1. A method for starting an engine, comprising:
via a controller, rotating the engine to a speed greater than a threshold speed via transferring torque from a first electric machine through a planetary carrier gear set and a sun gear to the engine; and
reducing torque output of the first electric machine at a rate in response to engine speed being greater than the threshold speed; and
ceasing to reduce torque output of the first electric machine at the rate in response to transferring torque from the engine to the first electric machine through the sun gear and to the planetary carrier gear set.

2. The method of claim 1, further comprising combusting fuel in the engine while the engine is being rotated via the first electric machine.

3. The method of claim 2, where combusting fuel in the engine includes operating the engine with spark timing retarded from minimum spark advance for a maximum torque generated at a particular engine speed and load.

4. The method of claim 3, where combusting fuel in the engine includes fully closing a throttle of the engine.

5. The method of claim 1, where reducing torque output of the first electric machine includes adjusting torque output of the first electric machine from a positive torque to a negative torque.

6. The method of claim 1, further comprising charging a battery via the first electric machine in response to transferring torque from the engine to the first electric machine.

7. The method of claim 1, further comprising advancing spark timing in response to transferring torque from the engine to the first electric machine.

8. A system, comprising:
an internal combustion engine;
a power split transmission coupled to the internal combustion engine, the power split transmission including two electric machines, a sun gear, a planetary carrier gear set, and a ring gear; and
a controller including executable instructions stored in non-transitory memory that cause the controller to rotate the internal combustion engine via a first electric machine of the two electric machines to start the internal combustion engine, and additional executable instructions reduce torque output of the first electric machine at a rate in response to a speed of the internal combustion engine exceeding a threshold speed, and additional instructions to further adjust torque output of the first electric machine in response to lash crossing between the sun gear and the planetary carrier gear set during engine starting.

9. The system of claim 8, further comprising additional instructions that cause the controller to initiate combustion in the internal combustion engine.

10. The system of claim 9, further comprising additional instructions that cause the controller to retard spark timing of the internal combustion engine and operate the internal combustion engine with a throttle of the internal combustion engine fully closed during starting of the internal combustion engine.

11. The system of claim 8, further comprising additional instructions to adjust control parameters of a proportional integral derivative controller to a first set of values during engine starting.

12. The system of claim 11, further comprising additional instructions adjust control parameters of the proportional integral derivative controller to a second set of values in response the speed of the internal combustion engine exceeding the threshold speed.

13. The system of claim 12, further comprising additional instructions to adjust control parameters of the proportional integral derivative controller to a third set of values in response the lash crossing between the sun gear and the planetary carrier gear set.

14. The system of claim 13, where the proportional integral derivative controller adjusts torque output of the first electric machine.

15. The system of claim 14, further comprising additional instructions to propel a vehicle via a second electric machine of the two electric machines.

16. A method for operating an engine, comprising:
via a controller, rotating the engine via adjusting torque of an electric machine based on output of a proportionate integral derivative (PID) controller operating with a first group of control parameters in response to an engine start request;
adjusting torque of the electric machine based on output of the PID controller operating with a second group of control parameters in response to engine speed exceeding a threshold speed; and
adjusting torque of the electric machine based on output of the PID controller operating with a third group of control parameters in response to a gear lash crossing having occurred.

17. The method of claim 16, where the second group of control parameters operate to reduce a rate of torque change of the electric machine.

18. The method of claim 17, further comprising combusting fuel in the engine and operating the engine with spark timing retarded from minimum spark advance for a maximum torque generated at a particular engine speed and load.

19. The method of claim 18, where the gear lash crossing is a first gear lash crossing since a most recent engine stop.

20. The method of claim 19, further comprising operating the engine with a fully closed throttle prior to the gear lash crossing occurring.
